(19) United States
(12) Patent Application Publication
(10) Pub. No.: US 2019/0242001 A1
(43) Pub. Date: Aug. 8, 2019

(54) METHOD FOR COATING A SURFACE OF A SOLID SUBSTRATE WITH A LAYER COMPRISING A CERAMIC COMPOUND, AND COATED SUBSTRATE THUS OBTAINED

(71) Applicants: COMMISSARIAT Á L'ÉNERGIE ATOMIQUE ET AUX ÉNERGIES ALTERNATIVES, Paris (FR); SAFRAN, Paris (FR)

(72) Inventors: Benjamin Bernard, Chambray-Les-Tours (FR); Aurélie Quet, Tours (FR); Emmanuel Herve, Tours (FR); Luc Bianchi, Moissy-Cramayel (FR); Aurélien Joulia, Moissy-Cramayel (FR); André Malie, Moissy-Cramayel (FR)

(21) Appl. No.: 16/341,956

(22) PCT Filed: Oct. 18, 2017
(86) PCT No.: PCT/FR2017/052868

§ 371 Date: Apr. 15, 2019

(30) Foreign Application Priority Data
Oct. 18, 2016 (FR) 1660103

(51) Int. Cl. C23C 4/11; C23C 4/134; C23C 28/04; F01D 5/28; F01D 9/04

(52) U.S. Cl. CPC C23C 4/11; C23C 4/134; C23C 28/042; F01D 5/288; F05D 2300/15; F05D 2230/90; F05D 2230/312; F05D 2300/6033; F01D 9/04

(57) ABSTRACT

A method for coating at least one surface of a solid substrate with at least one layer comprising at least one ceramic compound by a suspension plasma spraying (SPS) technique, in which at least one suspension of solid particles of at least one ceramic compound is injected into a plasma jet, and then the thermal jet that contains the solid particle suspension is sprayed onto the surface of the substrate, by way of which the layer comprising at least one ceramic compound is formed on the surface of the substrate; method characterised in that, in the suspension, at least 90 vol % of the solid particles have a larger dimension (referred to as d₉₀), such as a diameter, smaller than 15 μm, preferably smaller than 10 μm, and at least 50 vol % of the solid particles have a larger dimension, such as a diameter (referred to as d₅₀), no smaller than 1 μm. A substrate coated with at least one layer that can be obtained by the method. A part comprising the coated substrate and use of the layer in order to protect a solid substrate against degradations caused by contaminants such as CMAS.

### TECHNICAL FIELD

The present invention relates to a method for coating at least one surface of a solid substrate with at least one layer comprising at least one ceramic compound.

This layer is, in particular, a layer that is able to withstand infiltration and degradation at high temperature due to contaminants, in particular contaminants in the form of solid particles such as dusts, sands, or ashes. These contaminants may be, in particular, constituted by a mixture of oxides generally comprising lime (CaO), magnesium oxide (MgO), alumina (Al₂O₃) and silicon oxide (SiO₂). These contaminants are usually called CMAS.

The invention further relates to the solid substrate coated with a layer obtainable by the coating method according to the invention.

The invention also relates to a part comprising said solid substrate.

More particularly, the layer prepared by the method according to the invention is intended to be integrated within multilayer coatings protecting a solid substrate made of metal alloy or metal superalloy or ceramic matrix composite (CMC), optionally coated with a bonding layer that may itself also be optionally coated with a thermally insulating ceramic layer, and/or an anti-oxidation layer, and/or an anti-corrosion layer.

The technical field of the invention may be broadly defined as that of anti-CMAS coatings.

The invention finds particular application in gas turbines or propulsion systems used, in particular, in the aeronautical, spatial, naval and land-based industries for the protection of parts exposed to high temperatures such as, for example, parts of the turbine such as stationary and moving blades, distributors, turbine rings, shrouds, parts of the combustion chamber, or the nozzle.

### State of the Prior Art

To increase the efficiency of gas turbines, their operating temperature has to become higher and higher. The parts that constitute them are then subjected to increasingly severe environments in terms of skin temperature, thermomechanical stresses, or chemical aggressions.

Thus, over the years, the increase in operating temperatures of gas turbines has required the use of thermal barrier systems comprising a thermally insulating layer made of ceramic oxide, most often consisting of YSZ (Yttria-Stabilized Zirconia), i.e. zirconia stabilized with yttrine (yttrium oxide Y₂O₃), typically containing from 7 to 8% by mass of yttrium oxide Y₂O₃.

A thermal barrier system is a multilayer system composed of at least one thermally insulating layer making it possible to reduce the surface temperature of the structuring material, namely the surface temperature of the material constituting the part such as a part of a gas turbine that it is desired to protect thermally.

In industry, two technologies are currently used to prepare the YSZ insulating ceramic layer. These technologies are dry Atmospheric Plasma Spraying (APS), and Electron Beam-Physical Vapor Deposition (EB-PVD).

Plasma spraying leads to lamellar microstructures with low thermal conductivity but limited life during thermal cycling [1].

For parts that are strongly thermomechanically stressed, the EB-PVD method is preferred because of the resulting columnar microstructures which, despite less advantageous thermal conductivities, provide for thermomechanical stresses and ensure long service lives. The EB-PVD method is also preferred to the APS method for its ability to maintain air vents allowing for increased operating temperatures [1].

Ceramic coatings with improved thermal insulation properties have recently been obtained using specific materials or methods.

In particular, the production of YSZ deposits by Solution Precursor Plasma Spraying (SPPS) or Suspension Plasma Spraying (SPS) methods are noteworthy. The deposits obtained by these methods have varied microstructures that increase the thermal insulation of the coating while ensuring a significant thermal cycling resistance. The microstructures may be homogeneous (i.e. the pores or particles that make up the layer have no characteristic orientation at the micrometric scale), porous, vertically cracked, or columnar (i.e. the layer has a structure having, at the micrometric scale, a preferred orientation in the direction of the thickness of the layer, with an organization in the form of columnar domains and, between the columnar domains, empty spaces or inter-columnar spaces that reflect the compactness of the columnar stack and whose amplitude is flexible), with or without interpasses (resulting from the presence of unmelted (not melted) or partially melted particles within the deposit. The nanostructures may also have combinations of the various morphologies described above Examples of these microstructures are presented in documents [2] and [3].

Document [4] shows that the SPS method makes it possible to successfully prepare thermal barrier coatings on aeronautical parts of the turbine blade type, while allowing the preservation of vent holes.

However, other problems have emerged, requiring new features in thermal barrier systems. Thus, the increase in operating temperatures of gas turbines induces significant damages in the hot parts of the turbines due to contaminants, generally in the form of dusts, present in the environment of the parts of these turbines. These contaminants may, for example, in the case of a turbojet engine, be oxides, in the form of particles, originating either from the outside or from ablated elements on the parts situated in the colder zones. These contaminants are usually called CMAS and are usually composed of a mixture of oxides generally comprising lime (CaO), magnesium oxide (MgO), alumina (Al₂O₃) and silicon oxide (SiO₂). From temperatures of the order of 1150° C., melted CMAS infiltrate within the thermal barrier system and may lead, during thermal cycling, to stiffening, cracking and, ultimately, delamination of the thermal barrier system. Furthermore, a chemical interaction may be observed between the CMAS and the layers of the system, leading to the dissolution of the yttria-stabilized zirconia and the precipitation of new, less stable phases. These two phenomena may lead to a loss of integrity of the thermal barriers and constitute a brake on the increase of the operating temperature of the turbojet engines.

In addition to thermal barrier systems, environmental barrier systems may also experience this type of degradation by CMAS particles.

An environmental barrier system is a multilayer system, typically applied on metal surfaces or ceramic matrix composites. This environmental barrier system is composed of at least one layer that is resistant to corrosive environments.

Various approaches have been explored to propose so-called “anti-CMAS” materials that react with CMAS contaminants to form stable phases at high temperature that will stop and/or limit infiltration at the core of the coating.

In particular, apatite and/or anorthite phases formation appears to be able to stop CMAS infiltrations. Various materials have been identified for their ability to form these phases. The documents [5] and [6], in particular, present materials that make it possible to limit and/or stop the infiltration of CMAS. For example, rare earth zirconates of formula RE₂Zr₂O₇ (where RE=Sc, Y, La, Ce, Pr, Nd, Pm, Sm, Eu, Gd, Yb, Dy, Ho, Er, Tm, Tb, Lu), composite materials composed of Y₂O₃ and ZrO₂ and/or Al₂O₃ and/or TiO₂, hexa-aluminates, and rare earth mono- and di-silicates (the rare earth being Y or Yb), and mixtures of these materials, are mentioned.

The chemical incompatibility with other elements of the thermal barrier system and/or the low mechanical properties of the anti-CMAS compositions have led to the development of systems, architectures, comprising a first layer of YSZ and then a second layer of protection against CMAS, made of a material that can have an anti-CMAS effect. The documents [7], [8], [9] and [10] deal with such systems.

For the formation of this protective layer against CMAS, many deposition methods may be used, such as the APS, SPS, SPPS, EB-PVD methods, already mentioned above, including Physical Vapor Deposition (PVD), Chemical Vapor Deposition (CVD), or the sol-gel method, etc.

The production by the EB-PVD method of bilayer architectures, comprising a thermal insulating layer with a columnar microstructure protected by an anti-CMAS layer, induces the presence of inter-columnar spaces which, after infiltration of the CMAS and cooling, promotes stiffening of the system which may then delaminate.

Anti-CMAS coatings made by APS lead to non-columnar lamellar microstructures, with lamellae with large surfaces that are able to react with CMAS to form more stable phases. However, it is complicated to apply these layers on high pressure turbine parts, as this may obstruct the vent holes.

The SPS and SPPS methods, which provide nanostructured layers or finely structured layers, may be solutions for forming anti-CMAS layers having homogeneous microstructures without obstructing the vent holes.

Anti-CMAS layers obtained by SPS are currently produced with suspensions containing particles having sizes smaller than 1 μm (documents [9] and [10]).

However, it has been found that in the anti-CMAS layers obtained by SPS there are infiltration points of the CMAS contaminants through the layer, thus making the infiltration of the CMAS contaminants very significant at the core of the coating, under the anti-CMAS layer, unlike, for example, a deposit made by the APS technique.

Therefore, with regard to the foregoing, there is a need for a method, in particular for an SPS method, which makes it possible to prepare a ceramic layer on a solid substrate, more specifically an anti-CMAS layer, in particular offering increased resistance to infiltration by CMAS contaminants, while avoiding obstruction of the vent holes.

The solid substrate may be constituted simply by a simple support which is in the form of a solid bulk support or in the form of a layer, or the solid substrate may be constituted by a support on which there is a layer or a multilayer coating, for example, a multilayer thermal protection coating namely a thermal barrier system, or a multilayer coating for protection against corrosive environments, i.e. an environmental barrier system.

This method must allow the preparation of this layer on all types of substrates, whatever the geometry of the substrate, whatever the material constituting this substrate (i.e. more precisely the material constituting the support or the layer on which is deposited the layer prepared by the method), regardless of the structure, in particular the microstructure of the substrate (support or layer), and whatever the method by which this substrate (support or layer) is prepared.

In particular, the method according to the invention must allow the preparation of a ceramic layer, more specifically of an effective anti-CMAS layer, on a substrate (support or layer) prepared by a technique chosen from among EB-PVD, APS, SPS, SPPS, PVD, CVD, and sol-gel techniques, and all combinations of these techniques.

In particular, the method according to the invention must allow the preparation of a ceramic layer, more specifically of an effective anti-CMAS layer, on a substrate (support or layer) having a microstructure selected from among a columnar structure, a columnar and porous structure, a compact and porous columnar structure, a homogeneous structure, a homogeneous and porous structure, a dense structure, a dense and vertically cracked structure, a porous and vertically cracked structure, and all combinations of these techniques.

In particular, there is a need for a method that ensures operation of the turbojet engines at higher temperatures, without degradation of the system by the CMAS.

The goal of the invention is, inter alio, to provide a method for coating at least one surface of a solid substrate with at least one layer comprising at least one ceramic compound, which meets these needs, among others, and which does not does not present the disadvantages, defects, limitations and drawbacks of the prior art methods, especially prior art SPS methods, and which solves the problems of the prior art methods.

### DESCRIPTION OF THE INVENTION

This and other goals are achieved, according to the invention, by a method for coating at least one surface of a solid substrate with at least one layer comprising at least one ceramic compound by a Suspension Plasma Spraying (SPS) technique, in which at least one suspension of solid particles of at least one ceramic compound is injected into a plasma jet, and then the thermal jet which contains the suspension of solid particles is sprayed onto the surface of the substrate, whereby the layer comprising at least one ceramic compound is formed on the surface of the substrate; method characterized in that in the suspension, at least 90% by volume of the solid particles have a largest dimension (called d₉₀), such as a diameter, less than 15 μm, preferably less than 10 μm, and at least 50% by volume of the solid particles have a largest dimension (called d₅₀) such as a diameter, greater than or equal to 1 μm; method further characterized in that the ceramic compound is selected from compounds known as anti-CMAS compounds, preferably the ceramic compound is selected from rare earths zirconates of formula RE₂Zr₂O₂, where RE is Sc, Y, La, Ce, Pr, Nd, Pm, Sm, Eu, Gd, Yb, Dy, Ho, Er, Tm, Tb, or Lu, composites of Y₂O₃ with ZrO₂ and/or Al₂O₃ and/or TiO₂, hexa-aluminates, aluminum silicates, silicates of yttrium or of other rare earths, which silicates may be doped with one or more alkaline earth metal oxides, and mixtures thereof; more preferably, the ceramic compound is Gd₂Zr₂O₇.

Advantageously, in the suspension, at least 90% by volume of the solid particles have a largest dimension (called d₉₀), such as a diameter, less than 8 μm, preferably less than 5 μm.

Advantageously, in the suspension, at least 50% by volume of the solid particles have a largest dimension (called d₅₀) such as a diameter greater than or equal to 2 μm, preferably greater than or equal to 3 μm, more preferably greater than or equal to 4 μm, most preferably greater than or equal to 5 μm.

For example, d₅₀ may be 1 μm, 1.01 μm, 3 μm, 5 μm, or 5.5 μm.

For example, d₉₀ may be equal to 7 μm, 4 μm, 4.95 μm, 5 μm, 12 μm, 13 μm or 13.2 μm.

The invention covers all possible combinations of values of d₉₀ and d₅₀ mentioned above.

The analysis of the particle size of the suspension is carried out by laser diffraction granulometry according to the ISO 24235 standard.

The d₉₀ and the d₅₀ may be determined from the ISO 9276 standard.

In the following, the term “lamellar”, applied to a layer, means that the layer has a structure having, at the micrometric scale, elementary bricks having a preferred orientation in the direction perpendicular to the thickness of the layer.

The term “columnar”, applied to a layer, means that the layer has a structure having, at the micrometric scale, a preferred orientation of elementary bricks in the direction of the thickness of the layer, wherein these bricks are organized in the form of columns.

The term “homogeneous” applied to a layer means that the layer has a structure formed of elementary bricks that have no characteristic orientation at the micrometric scale. Similarly, the porosity of the layer has no characteristic orientation at the micrometric scale.

The method according to the invention is fundamentally different from the methods of the prior art in that it implements a specific deposition technique, namely a suspension plasma spraying technique (SPS), and in that the suspension contains particles which have a very specific particle size, namely a particle size defined by the fact that at least 90% by volume of the solid particles have a largest dimension (called d₉₀), such as a diameter, of less than 15 μm, preferably less than 10 μm, and at least 50% by volume of the solid particles have a largest dimension such as a diameter (called d₅₀) greater than or equal to 1 μm.

Such a granulometry of the suspension particles is neither described nor suggested in the prior art, where the SPS methods used to prepare, for example, anti-CMAS layers, use suspensions containing “small” particles having sizes less than 1 μm, i.e. with a d₅₀ of less than 1 μm, in particular a nanometric d₅₀ and/or d₉₀, i.e. greater than or equal to 1 nanometer and less than or equal to 100 nanometers, or a submicrometric d₅₀ and/or d₉₀, i.e. greater than 100 nanometers and less than 1000 nanometers.

In the prior art, the use of small-sized particles promotes the appearance of infiltration points of the contaminants, for example CMAS, through the layer and thus makes the infiltration of contaminants, for example CMAS, more significant at the core of the coating. This behavior of the anti-CMAS layers obtained by SPS in the prior art may be attributed to the low tortuosity of the porous network of the layers obtained from fine particles.

On the contrary, the layer obtained by the method according to the invention has a much greater tortuosity, because of the use of much larger particles. This significant tortuosity makes it possible to slow down the infiltration, for example of liquid CMAS in the thickness of the layer.

In contrast to the APS technique in which the injection of the particles is carried out using a carrier gas, the injection of the particles in the SPS technique performed according to the invention, is carried out on the basis of a suspension of particles conveyed in a pressurized liquid vector. This makes it possible to make the particles having a d₉₀ of less than 15 μm, preferably less than 10 μm, penetrate by inertia effect to the core of the plasma jet without undue disturbance of the latter, and thus to optimize their transport and heating by the plasma jet.

The method according to the invention does not have the drawbacks of the methods of the prior art and provides a solution to the problems of the methods of the prior art.

Advantageously, the layer obtained by the method according to the invention has a lamellar microstructure and a tortuous porous network.

Advantageously, the layer obtained by the method according to the invention comprises at the same time:
lamellae resulting from the melting of the solid particles of the suspension,
solid particles resulting from the partial melting of the solid particles of the suspension, and
unmelted solid particles of the suspension.

The layer obtained by the method according to the invention may optionally have cracks, but it is non-columnar and non-homogeneous, whatever the microstructure of the surface to be coated.

The layer obtained by the method according to the invention thus has a microstructure which is particularly adapted to its anti-CMAS function. It allows the formation on its surface, with a limited infiltration of its porous network, of stable phases that are products of the reaction between the material of the layer and the liquid CMAS. These stable phases block the infiltration of CMAS deep into the coating.

Due to the specific size of the initial particles used in the suspension, the layer according to the invention has a stack of lamellae that are melted (resulting from the melting of the solid particles of the suspension), partially melted (solid particles resulting from the partial melting of the solid particles of the suspension), and of unmelted particles (unmelted solid particles of the suspension that have retained their initial shape, for example spherical). The layer thus has a tortuous porous network making its access by contaminants, its infiltration by contaminants, such as liquid CMAS, difficult.

Unlike the layers obtained by the SPS technique implementing the suspensions conventionally used in this technique, whose particles have a d₅₀ of less than 1 μm, in particular a nanometric d₅₀ and/or d₉₀, i.e. greater than or equal to equal to 1 nanometer and less than or equal to 100 nanometers, or submicrometric, i.e. greater than 100 nanometers and less than 1000 nanometers, wherein the microstructure of the layer according to the invention is lamellar. It is neither columnar nor homogeneous.

The lamellar microstructure of the layer obtained by the method according to the invention ensures increased resistance with respect to the particulate mechanical erosion, in particular, the resistance with respect to the particulate mechanical erosion is greater than a homogeneous or columnar microstructure obtained by an SPS technique using the suspensions traditionally used in this technique with “small” particles.

In addition, advantageously, the layer according to the invention is characterized in that it does not obstruct the vent holes. In fact, the particle size distribution of the initial particles of the suspension is sufficiently fine to lead to more finely structured layers when compared to layers prepared by an APS technique.

The method according to the invention, by using suspended particles having a d₉₀ of less than or equal to 10 μm and a d₅₀ greater than or equal to 1 μm, makes it possible to prepare layers with microstructures that approximate the microstructures obtained by the APS technique without presenting the defects of these microstructures, i.e. by not obstructing the vent holes.

Finally, the use according to the method of the invention of suspended particles having a d₉₀ of less than 15 μm, preferably less than 10 μm, and a d₅₀ greater than or equal to 1 μm, makes it possible to obtain a layer with a lamellar microstructure making it possible to increase the chemical resistance to contaminants such as CMAS and the mechanical resistance to particle erosion, while not obstructing vent holes.

Advantageously, the layer has a porosity of 5 to 50% by volume, preferably 5 to 20% by volume.

Advantageously, the layer has a thickness of 10 μm to 1000 μm, preferably 10 to 300 μm.

There is no limitation on the substrate which may be coated with a layer by the method according to the invention.

The method according to the invention ensures the preparation of a layer having the advantageous properties exposed herein on all types of substrates, whatever the geometry of this substrate, whatever the material constituting this substrate (i.e. more precisely the material constituting the support or the layer on which the layer prepared by the method is deposited), regardless of the structure, in particular the microstructure of the substrate (support or layer), whatever the morphology of this substrate, and whatever the method by which this substrate (support or layer) was prepared.

In particular, the method according to the invention makes it possible to prepare a ceramic layer, more specifically an effective anti-CMAS layer, on a substrate (support or layer) prepared by a technique chosen from among EB-PVD, APS, SPS, SPPS, PVD, CVD, sol-gel techniques, and all combinations of these techniques.

The solid substrate may consist simply of a simple solid support, which is for example in the form of a massive, bulk solid support or in the form of a layer, and is deposited, by the method according to the invention, the layer comprising at least one ceramic compound directly on at least one surface of said support.

Or, else, the solid substrate may consist of a solid support on which there is a single layer (different from the layer of at least one ceramic compound prepared by the method according to the invention), or a stack of several layers (different from the layer of at least one ceramic compound prepared by the method according to the invention), and the layer comprising at least one ceramic compound is deposited on at least one surface of said single layer, or on at least one surface of the upper layer of said stack of layers.

Said support may be made of a material chosen from materials that are sensitive to an infiltration and/or an attack by contaminants such as CMAS.

Said support may be, in particular, made of a material chosen from among metals, metal alloys, such as superalloys like AM1, René, and CMSX®-4 superalloys, ceramic matrix composites (CMC), such as SiC matrix composites, C—SiC mixed matrix composites, and combinations and/or mixtures of the aforementioned materials.

Superalloys are metal alloys characterized by a mechanical strength and a resistance to oxidation and corrosion at high temperatures.

In the context of the invention, they are preferably monocrystalline superalloys.

Such a superalloy, commonly used, is, for example, the superalloy called AM1, which is a nickel based superalloy, having a mass composition of 5 to 8% Co, 6.5 to 10% Cr, 0.5 to 2.5% Mo, 5 to 9% W, 6 to 9% Ta, 4.5 to 5.8% Al, 1 to 2% Ti, 0 to 1.5% Nb, and C, Zr, B less than 0.01% each.

The AM1 superalloy is described in U.S. Pat. No. 4,639,280.

The family of superalloys referred to as Rene was developed by General Electric®.

The CMSX®-4 superalloy is a trademark of the Cannon-Muskegon® company.

The layer of the invention may be applied to parts consisting of these superalloys.

Advantageously, the single layer or said stack of layers that is on the support forms a monolayer or multilayer thermal protection coating on the support, i.e. a thermal barrier system, and/or a monolayer or multilayer coating for protection against corrosive environments, i.e. an environmental barrier system.

Advantageously, the single layer may be chosen from among bonding layers, and thermal or environmental barrier layers, such as layers, in particular ceramic layers, which are thermally insulating layers, layers in particular ceramic layers which are, anti-oxidation layers, and layers especially ceramic layers, which are anti-corrosion layers.

Advantageously, the stack of several layers that is on the support may comprise, starting from the support:
a bonding layer which covers the support;
one or more layers chosen from among thermal barrier layers and the environmental barrier layers, such as the layers, in particular ceramic layers, which are thermally insulating layers, layers in particular ceramic layers, which are anti-oxidation layers, and layers; especially ceramic layers, which are anti-corrosion layers;

or the stack of several layers on the support comprise:
several layers chosen from among thermal barrier layers and environmental barrier layers, such as layers, in particular ceramic layers, which are thermally insulating layers, in particular ceramic layers, which are anti-oxidation layers, and layers, especially ceramic layers, which are anti corrosion layers.

Advantageously, the thermal barrier layers and the environmental barrier layers, such as layers, in particular ceramic layers, which are thermally insulating layers, layers in particular ceramic layers which are anti-oxidation layers, and layers, in particular ceramic layers, which are anti-corrosion layers, may be layers prepared by a technique selected from EB-PVD, APS, SPS, SPPS, sol-gel, PVD, CVD techniques, and combinations of these techniques.

Advantageously, the thermal barrier layers are made of a material chosen from zirconium or hafnium oxides, stabilized with yttrium oxide or with other rare earths oxides, aluminium silicates, silicates of yttrium or of other rare earths, wherein these silicates may be doped with alkaline earth metal oxides, and rare earth zirconates, which crystallize according to a pyrochlore structure, and combinations and/or mixtures of the abovementioned materials.

Preferably, the thermal barrier layers are made of yttria-stabilized zirconia (YSZ).

Advantageously, the environmental barrier layers are made of a material chosen from aluminium silicates, optionally doped with alkaline earth elements, rare earth silicates, and combinations and/or mixtures of the abovementioned materials.

Advantageously, the bonding layer may be made of a material chosen from metals, metal alloys such as β-NiAl metal alloys, modified or not by Pt, Hf, Zr, Y, Si or combinations of these elements, γ-Ni-γ-Ni₃Al metal alloys modified or not by Pt, Cr, Hf, Zr, Y, Si or combinations thereof, MCrAlY alloys where M is Ni, Co, NiCo, Si, SiC, SiO₂, mullite, BSAS, and combinations and/or mixtures of the aforementioned materials.

According to one embodiment, the substrate may consist of a support made of a metal alloy such as a superalloy, preferably monocrystalline, or of a ceramic matrix composite (CMC), coated with a metal bonding layer that is itself coated with a layer, such as a ceramic layer selected from the thermal barrier layers and the environmental barrier layers.

According to another embodiment, the substrate consists of a support made of a metal alloy such as a superalloy or consisting of a ceramic matrix composite (CMC), coated with a metal bonding layer that is itself coated with a ceramic thermal barrier layer made of zirconia (ZrO₂) stabilized with yttrine (Y₂O₃).

According to yet another embodiment, the substrate may consist of a support made of a metal alloy such as a superalloy or may consist of a ceramic matrix composite (CMC), coated with a metal bonding layer that is itself coated with a ceramic thermal and/or environmental barrier layer made by a technique selected from among APS, EB-PVD, SPS, SPPS, sol-gel, CVD techniques, and combinations of these techniques.

The plasma spraying technique of a suspension is used to produce the layer according to the invention. This consists in injecting a liquid suspension containing particles of the material of the layer to be prepared into a flow with high thermal and kinetic energy (for example a plasma jet which may be produced by a DC plasma torch).

Generally, the suspension contains from 1 to 40% by mass, preferably from 8 to 15% by mass of solid particles, for example 12% by mass of solid particles.

The solvent of the suspension may be selected from water, alcohols such as aliphatic alcohols from 1 to 5 C such as ethanol and mixtures thereof.

The suspension is injected from a pressurized tank using a mechanical injector.

In the method according to the invention, the injection of the suspension into the plasma jet is generally made radially. The inclination of the injector relative to the longitudinal axis of the plasma jet may vary from 20 to 160°, but is preferably 90°. In a manner known to the man skilled in the art, the orientation of the injector makes it possible to optimize the injection of the suspension into the plasma jet, and thus to promote the formation of a layer of good quality on the surface of the substrate.

The injector may be moved in the longitudinal direction of the plasma jet. The closer the injector is to the surface of the substrate to be coated, the shorter is the residence time of the particles in the plasma jet, thus making it possible to control the thermokinetic treatment imposed on the particles.

The diameter of the injector may vary between 50 μm and 300 μm.

The injection device may be provided with one or more injectors, for example according to the amount of suspension and/or the number of different suspensions to be injected.

The suspension thus injected will fragment upon contact with the plasma jet. The solvent will then evaporate, and the particles will be heat-treated and accelerated towards the substrate, and thus form a layer.

The plasma jet may be generated from a plasma-forming gas advantageously chosen from argon, helium, dihydrogen, dinitrogen, the binary mixtures of the four gases mentioned, the ternary mixtures of the four gases mentioned.

The plasma jet generation technique is chosen from an arc plasma, blown or not, an inductive plasma or a radiofrequency plasma. The generated plasma may operate at atmospheric pressure or at a lower pressure. In the case of an arc plasma, the latter may be extended by the stack of neutrodes between the cathode and the anode and between which the arc is generated.

According to a preferred embodiment of the method which is the subject of the invention, the injection is carried out by means of an injection system having an injection diameter of between 50 and 300 μm at an injection pressure of the injection system between 1 and 7 bar and from a suspension comprising between 1% and 40% by weight of solid particulate elements.

The invention further relates to the substrate coated with at least one layer obtainable by the method according to the invention, as described above.

Advantageously, the layer has a lamellar microstructure and a tortuous porous network.

Advantageously, the layer comprises at the same time:
lamellae resulting from the melting of the solid particles of the suspension,
solid particles resulting from the partial melting of the solid particles of the suspension, and
unmelted solid particles of the suspension.

Advantageously, the layer has a porosity of 5 to 50% by volume, preferably 5 to 20% by volume.

Advantageously, the layer has a thickness of 10 μm to 1000 μm, preferably 10 μm to 300 μm.

The invention also relates to a part comprising said coated substrate.

This part may be a part of a turbine, such as a turbine blade, a distributor, a turbine ring shroud, or a part of a combustion chamber, or a part of a nozzle, or more generally any part subjected to attacks by liquid and/or solid contaminants such as CMAS.

This turbine may be, for example, an aeronautical turbine or a land-based turbine.

The invention also relates to the use of the layer obtainable by the method according to the invention, for protecting a solid substrate against degradation caused by contaminants such as CMAS.

The invention finds particular application in gas turbines or propulsion systems used, in particular, in the aeronautical, space, marine and land-based industries, for the protection of parts exposed to high temperatures such as, for example, parts of the turbine such as stationary and moving blades, distributors, turbine rings, shrouds parts of the combustion chamber or of the nozzle.

### BRIEF DESCRIPTION OF THE DRAWINGS

FIG. 1 is a schematic sectional side view which shows a multilayer system whose top layer is an “anti-CMAS” layer 1 according to the invention, which is obtained by the method according to the invention implementing the SPS technique. with initial particles having a d₉₀ less than 10 μm and a d₅₀ greater than or equal to 1 μm.

FIG. 2 is a schematic sectional side view which shows in a simplified manner the multilayer system represented in FIG. 1, and the upper layer of which is an “anti-CMAS” layer 1 according to the invention and that is obtained by the method according to the invention implementing the SPS technique with initial particles having a d₉₀ less than 15 μm, preferably less than 10 μm, and a d₅₀ greater than or equal to 1 μm.

FIG. 3 shows a micrograph taken with Scanning Electron Microscope (SEM) using backscattered electrons of a polished section of the sample prepared in example 1, which comprises an anti-CMAS layer 1 obtained by SPS with initial particles having a d₉₀ less than 10 μm and a d₅₀ greater than or equal to 1 μm made on the surface of a porous columnar YSZ layer 6 obtained by SPS.

The scale shown in FIG. 3 represents 100 μm.

FIG. 4 shows a micrograph taken with Scanning Electron Microscope (SEM) using backscattered electrons of a polished section of the sample prepared in Example 2, which comprises an anti-CMAS layer 1 obtained by SPS with initial particles. having a d₉₀ less than 10 μm and a d₅₀ greater than or equal to 1 μm, and made on the surface of a porous compact columnar YSZ layer 7 obtained by SPS. The scale shown in FIG. 4 represents 100 μm.

FIG. 5 shows a micrograph taken with Scanning Electron Microscope (SEM) using backscattered electrons of a polished section of the sample prepared in Example 3, which comprises an anti-CMAS layer 1 obtained by SPS with initial particles having a d₉₀ less than 10 μm and a d₅₀ greater than or equal to 1 μm, and made on the surface of a columnar YSZ layer 8 obtained by EB-PVD.

The scale shown in FIG. 5 represents 100 μm.

FIG. 6 shows a micrograph taken with Scanning Electron Microscope (SEM) using backscattered electrons of a polished section of the anti-CMAS layer 1 obtained by SPS in Example 3 on the surface of a columnar YSZ layer 8 obtained by EB-PVD.

The observation is performed after CMAS infiltration.

The scale shown in FIG. 6 represents 5 μm.

FIG. 7A shows a micrograph taken with Scanning Electron Microscope (SEM) using backscattered electrons, and FIG. 7B shows an Energy Dispersive Spectroscopy (EDS) analysis of the silicon of a polished section of the anti-CMAS layer 1 (similar to the layer 13 of FIG. 9A) obtained by SPS in Example 4 at the surface of an YSZ layer 11 obtained by APS. The observation is performed after CMAS infiltration.

The scale shown in FIGS. 7A and 7B represents 25 μm.

FIG. 8A shows another micrograph taken with Scanning Electron Microscope (SEM) using backscattered electrons, and FIG. 8B shows an EDS analysis of the silicon of a polished section of the anti-CMAS layer 1 (similar to layer 13 in FIG. 9A) according to the invention, obtained by SPS in Example 4 at the surface of a YSZ layer 11 obtained by APS.

The observation is performed in an area with a cracking 12 after CMAS infiltration.

The scale shown in FIGS. 8A and 8B represents 25 μm.

FIG. 9A shows yet another micrograph taken with Scanning Electron Microscope (SEM) using backscattered electrons and an EDS analysis of the silicon of a polished section of an anti-CMAS layer 13 of Gd₂Zr₂O₇ obtained in Example 4, by SPS, with initial particles having a d₉₀ of 7 μm and a d₅₀ of 3 μm. This layer is made on the surface of a YSZ layer 11 obtained by APS.

The scale shown in FIG. 9A represents 25 μm.

The observation is performed in an area with cracking after CMAS infiltration.

FIG. 9B shows a micrograph taken with Scanning Electron Microscope (SEM) using backscattered electrons (left) and an EDS analysis of the silicon (right) of a polished section of an anti-CMAS layer 14 of Gd₂Zr₂O₇ according to the invention, and obtained in Example 5, by SPS, with initial particles having a diameter of 4.95 μm and a d₅₀ of 1.01 μm, on the surface of a YSZ layer 11 obtained by APS.

The observation is carried out in a zone exhibiting cracking after CMAS infiltration.

The scale shown in FIG. 9B represents 25 μm.

FIG. 9C shows a micrograph taken with Scanning Electron Microscope (SEM) using backscattered electrons and an EDS analysis of the silicon of a polished section of the anti-CMAS layer 15 of Gd₂Zr₂O₇ obtained in Example 6, which does not conform to the invention by SPS, with initial particles having a d₉₀ of 0.89 μm and a d₅₀ of 0.41 μm. This layer is made on the surface of a YSZ layer 11 obtained by APS. The observation is performed in an area with cracking after CMAS infiltration.

The scale shown in FIG. 9C represents 25 μm.

FIG. 10 shows a diffractogram obtained in X-ray diffraction after CMAS infiltration of the anti-CMAS layer 13 obtained in Example 4.

FIG. 11 shows a micrograph taken with Scanning Electron Microscope (SEM) using backscattered electrons of a polished section of the sample prepared in Example 11. This sample comprises an anti-CMAS layer consisting of Gd₂Zr₂O₇ prepared at the surface of a YSZ layer 8, columnar, obtained by an EB-PVD method. The anti-CMAS layer is prepared in accordance with the invention by an SPS method using a suspension containing initial particles having a d₉₀ of 13.2 μm and a d₅₀ greater than or equal to 1 μm, namely 5.5 μm.

The scale shown in FIG. 11 represents 100 μm.

FIG. 12 shows a micrograph taken with Scanning Electron Microscope (SEM) using backscattered electrons of a polished section of the anti-CMAS layer 21 obtained by SPS in example 12 on a self-supporting substrate 11 made of yttria-stabilized zirconia in a phase t′ and obtained by APS.

The observation is performed after CMAS infiltration (Example 13).

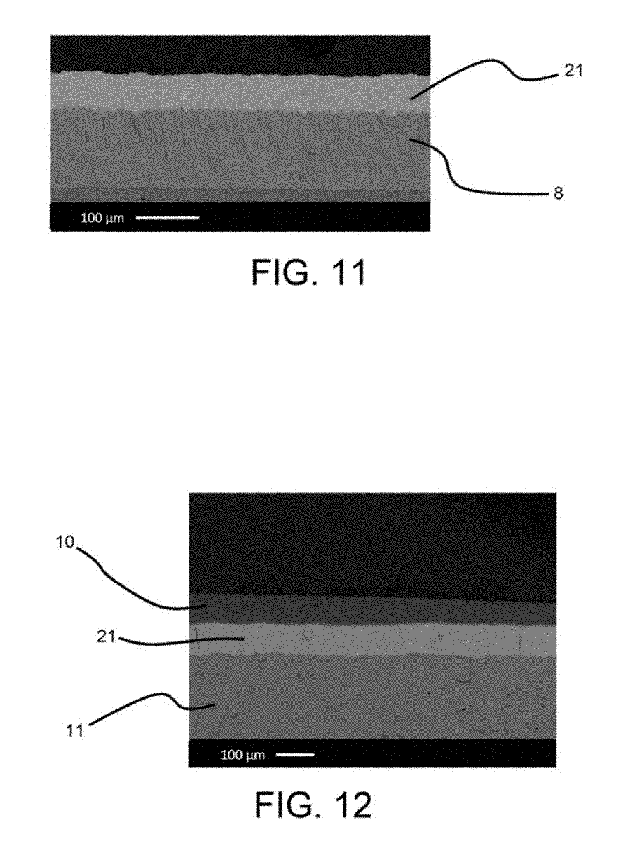

The scale shown in FIG. 12 represents 100 μm.

### DETAILED PRESENTATION OF PARTICULAR EMBODIMENTS

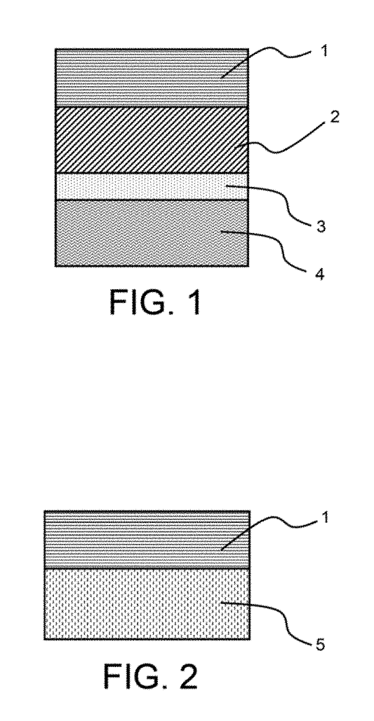

FIG. 1 shows an embodiment of the method according to the invention, in which the layer according to the invention prepared by the method according to the invention, 1, is deposited on the surface of a system comprising the layers 2, 3, 4, shown in FIG. 1.

The various layers of the stack 2, 3, 4 may represent, by way of example but not exclusively, the layers of a thermal barrier system applied to superalloy aeronautical parts.

Advantageously, the layer 2 may be made of a material chosen from the materials of thermal barrier systems and/or environmental barrier systems such as, for example, zirconia (ZrO₂) and/or yttrine (Y₂O₃) allowing a stabilization of the phase t′, and all other suitable materials, as well as combinations and/or mixtures of these materials.

In addition, advantageously, the layer 2 may be produced by a deposition method, technique, chosen from among the EB-PVD, APS, SPS, SPPS, sol-gel and CVD methods, and all the other methods capable of producing this layer, as well as combinations of these methods.

Advantageously, the layer 2 has a microstructure that is characteristic of the deposition method, technique used. This layer may, for example, non-exclusively present a columnar microstructure, a columnar and porous microstructure, a compact and porous columnar microstructure, a homogeneous microstructructure, a homogeneous and porous microstructructure, a dense microstructure, a dense and vertically cracked microstructructure, a porous and vertically cracked microstructructure.

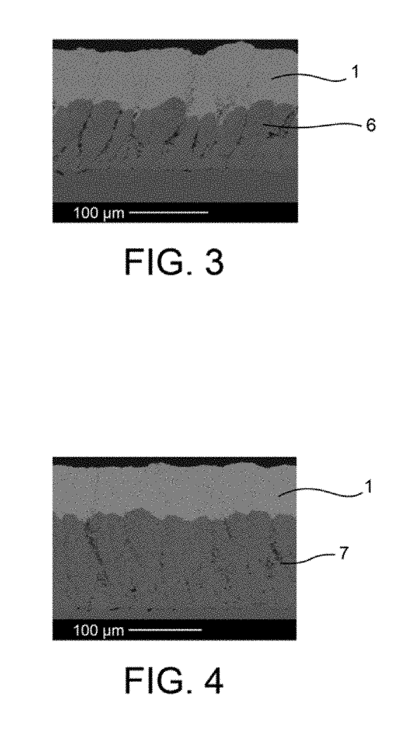

According to a first embodiment, the layer 1 according to the invention may be applied to a layer 2 having a porous columnar microstructure obtained by SPS (layer 6 in FIG. 3).

According to a second embodiment, the layer 1 according to the invention may be applied to a layer 2 having a porous compact columnar microstructure obtained by SPS (layer 7 in FIG. 4).

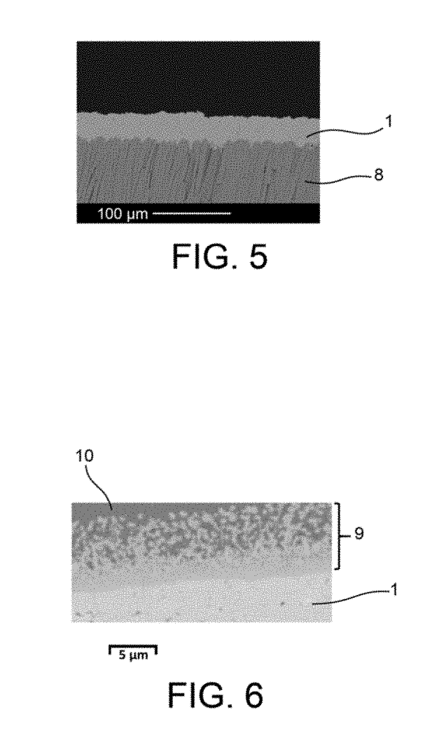

According to a third embodiment, the layer 1 according to the invention may be applied to a layer 2 having a columnar microstructure obtained by EB-PVD (layer 8 in FIG. 5).

Advantageously, the layer 2 may have a function of a thermal barrier and/or an environmental barrier. This layer also allows, but not exclusively, the guarantee of good performances in terms of lifetime and thermal insulation or protection against oxidation and humid corrosion.

Advantageously, the layer 3 serves as a bonding layer.

The layer 3 may be made of a material chosen from metals, metal alloys such as β-NiAl metal alloys (modified or not modified by Pt, Hf, Zr, Y, Si or combinations of these elements), aluminides of γ-Ni-γ′-Ni₃Al alloy (modified or otherwise by Pt, Cr, Hf, Zr, Y, Si or combinations of these elements), the alloys MCrAlY (where M=Ni, Co, NiCo), the Si, SiC, SiO₂, mullite, BSAS, and all other suitable materials, as well as combinations and/or mixtures of these materials.

Advantageously, the layer 3 may comprise an oxide layer obtained by oxidation of the elements of the layer 3, as described above. For example, but not exclusively, the layer 3 may be an alumino-forming layer, i.e. the oxidation of the layer 3 may advantageously produce an α-alumina layer.

Advantageously, the layer 4 is part of a part or of an element of a part made of a material chosen from metal alloys, such as metal superalloys, ceramic matrix composites (CMC), and combinations and/or mixtures of these materials. The material of the layer 4 may in particular be chosen from AM1, Rene, and CMSX®-4 superalloys.

In FIG. 2, the layer 1, and the system comprising the layers 2, 3, 4, shown in FIG. 1 are simplified to two elements, namely:
an anti-CMAS layer 1 according to the invention obtained by the method according to the invention implementing the SPS technique with particles of the injected suspension having a d₉₀ of less than 10 μm and a d₅₀ greater than or equal to 1 μm;
a layer 5 which may exactly describe the system of the layers 2, 3, 4 of FIG. 1, or one or more layers of the system of the layers 2, 3, 4 of FIG. 1, or one or more combinations of layers of the system of layers 2, 3, 4 of FIG. 1. This system is coated with an anti-CMAS layer 1 obtained by SPS with injected particles having a d₉₀ less than 15 μm, preferably less than 10 μm, and a d₅₀ greater than or equal to 1 μm.

Thus, advantageously, the layer 1 according to the invention may be applied to the surface of a layer 5. This layer 5 may include in an independent and/or combined way layers 2, 3, 4.

Advantageously, the layers 2 and 3 and/or the layer 5 allow, but not exclusively, the provision of a thermal and/or environmental barrier function. They also allow, but not exclusively, the guarantee of good performance in terms of service lifetime and thermal insulation or protection against oxidation and humid corrosion. Advantageously, the addition of the layer 1 according to the invention does not degrade the performance of the systems, described in FIGS. 1 and 2, on which it is applied.

Advantageously, the microstructure of the layer 1 has a homogeneous and/or cracked morphology, but not exclusively, whether it is carried out on the layer 2 or the layer 5, and whatever the microstructure and/or the composition of the layer 2 or layer 5.

Advantageously, the layer 1 according to the invention reacts with CMAS at high temperature, more precisely at a temperature above the melting temperature of CMAS, to form a reactive zone 9 (FIG. 6) beyond which CMAS penetration within layer 1 is stopped and/or limited.

Finally, the solidified CMAS 10 are thus observed on the surface of the coating (see examples, FIG. 6).

Advantageously, zone 9 is composed of reaction products between CMAS and layer 1 including, but not exclusively, apatite and/or anorthite and/or zirconia and/or other reaction products phases and/or combinations and/or mixtures of these phases.

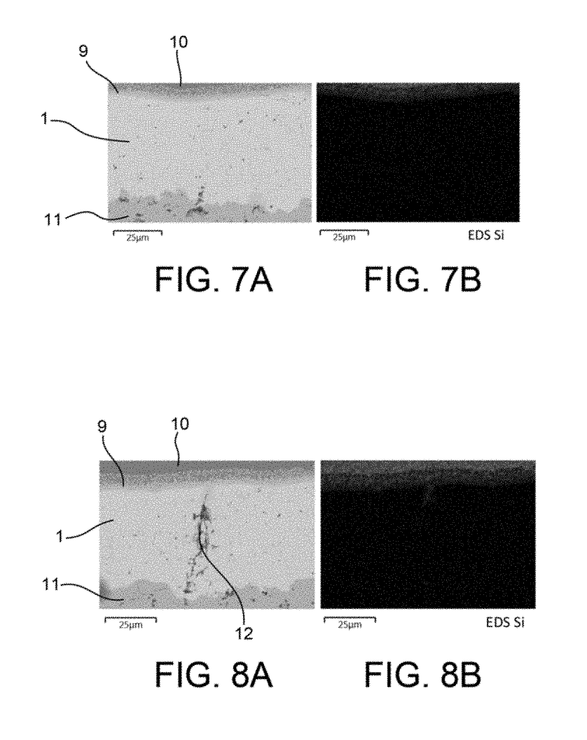

For example, no CMAS infiltration within the layer 1 deposited on a layer 11 obtained by APS is observed after a CMAS infiltration test beyond the reaction zone 9 (FIGS. 7A and 7B). Advantageously, the layer 11 obtained by APS is included in the description of the layer 2 described in FIG. 1.

Similarly, no CMAS infiltration within layer 1 deposited on a layer 11 is obtained by APS after a CMAS infiltration test beyond reaction zone 9 (FIGS. 8A and 8B). The crack 12 observed within layer 1 deposited on a layer 11 obtained by APS, is rapidly clogged by reaction products similar to those composing zone 9 (FIGS. 8A and 8B). Advantageously, the layer 11 obtained by APS is included in the description of the layer 2 described in FIG. 1.

It should be noted that, when a layer 1 according to the invention is produced by the method according to the invention, it is possible before coating the substrate (including layers 2 to 4 of FIG. 1 and/or layer 5 of FIG. 2) by the layer 1, to prepare and/or clean the surface to be coated in order to eliminate residues and/or contaminants (inorganic and/or organic) which would be prone to prevent the deposition and/or to degrade the adhesion and/or to affect the microstructure. The surface preparation may be the formation of a surface roughness by sanding, the oxidation of the substrate to generate a thin oxide layer and/or a combination of these preparation methods.

The invention will now be described with reference to the following examples, given by way of illustration but not limitation.

To prepare the anti-CMAS layers, suspensions of ceramic particles in ethanol are first prepared by placing ceramic particles in suspension in ethanol to obtain suspensions having a ceramic concentration of 12% by mass.

The suspensions thus prepared are then injected into a blown arc plasma using an assembly consisting of:

an Oerlikon-Metco® F4-VB and/or Oerlikon-Metco® Triplex Direct Current Pro200 plasma torch;
a robotic device on which the torch is placed and which allows its movement;
a device for fixing the surface to be coated at a defined distance from the torch. The combination of the movement authorized by this device and that of the preceding device makes it possible to coat the surface of a sample;
a suspension injection device.

In Examples 1, 2, 3, and 4, the layer is made with an Oerlikon-Metco® Triplex Pro200 torch, with a distance of 70 mm between the torch outlet and the substrate, using a plasma-forming gas mixture consisting of 80% by volume of argon and 20% by volume of helium.

In Example 5, the layer is made with an Oerlikon-Metco® Triplex Pro200 torch, with a distance of 60 mm between the torch outlet and the substrate, using a plasma-forming gas mixture consisting of 80% by volume of argon and 20% by volume of helium.

In Example 6, the layer is made with an Oerlikon-Metco® type F4-VB torch, with a distance of 50 mm between the torch outlet and the substrate, using a plasma-forming gas mixture consisting of 62% by volume of argon and 38% by volume of helium.

### EXAMPLES

### Example 1

In this example, an anti-CMAS layer according to the invention is prepared by the method according to the invention (see FIG. 3).

The anti-CMAS layer 1, consisting of Gd₂Zr₂O₇, is prepared on the surface of a porous, columnar YSZ layer 6, obtained by an SPS method. The anti-CMAS layer is prepared by an SPS method using a suspension containing initial particles having a d₉₀ of less than 10 μm, namely a d₉₀ of 7 μm, and a d₅₀ greater than or equal to 1 μm, namely 3 μm.

The thus prepared sample constituted by the anti-CMAS layer on the substrate falls within the scope of the system shown in FIGS. 1 and 2.

FIG. 3 shows a Scanning Electron Microscope (SEM) micrograph using backscattered electrons of a polished section of the sample prepared in this example.

### Example 2

In this example, an anti-CMAS layer according to the invention is prepared by the method according to the invention.

The anti-CMAS layer 1 consisting of Gd₂Zr₂O₇ is prepared on the surface of a columnar, compact, porous YSZ layer 7 obtained by an SPS method. The anti-CMAS layer is prepared by an SPS method using a suspension containing initial particles having a d₉₀ of less than 10 μm, namely a d₉₀ of 7 μm, and a d₅₀ greater than or equal to 1 μm, namely 3 μm.

The thus prepared sample constituted by the anti-CMAS layer on the substrate falls within the scope of the system shown in FIGS. 1 and 2.

FIG. 4 shows a Scanning Electron Microscope (SEM) micrograph using backscattered electrons of a polished section of the sample prepared in this example.

### Example 3

In this example, an anti-CMAS layer according to the invention is prepared by the method according to the invention.

The anti-CMAS layer 1 consisting of Gd₂Zr₂O₇ is prepared on the surface of a YSZ columnar layer 8 that is obtained by an EB-PVD method. The anti-CMAS layer is prepared by an SPS method using a suspension containing initial particles having a d₉₀ of less than 10 μm, namely a d₉₀ of 7 μm, and a d₅₀ greater than or equal to 1 μm, namely 3 μm.

The thus prepared sample constituted by the anti-CMAS layer on the substrate falls within the scope of the system shown in FIGS. 1 and 2.

FIG. 5 shows a Scanning Electron Microscope (SEM) micrograph using backscattered electrons of a polished section of the sample prepared in this example.

### Example 4

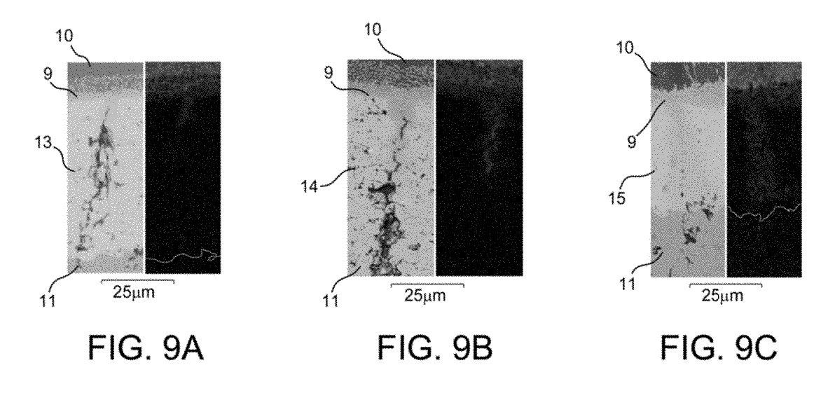

In this example, an anti-CMAS layer according to the invention is prepared by the method according to the invention (see FIG. 9A after infiltration by CMAS).

The anti-CMAS layer 13 consisting of Gd₂Zr₂O₇ is obtained by SPS using a suspension containing particles of Gd₂Zr₂O₇ having a d₉₀ of 7 μm and a d₅₀ of 3 μm. The layer is made on a self-supported substrate 11 made of yttria-stabilized zirconia stabilized in a phase t′ and obtained by APS.

### Example 5

In this example, an anti-CMAS layer according to the invention is prepared by the method according to the invention (see FIG. 9B after infiltration by CMAS).

The anti-CMAS layer 14 consisting of Gd₂Zr₂O₂ is obtained by SPS using a suspension containing Gd₂Zr₂O₂ particles having a d₉₀ of 4.95 μm and a d₅₀ of 1.01 μm. The layer is made on a self-supporting substrate 11 of yttria-stabilized zirconia stabilized in a phase t′ and obtained by APS.

### Example 6 (Comparative)

In this example, an anti-CMAS layer not according to the invention is prepared by a method which is not in accordance with the invention (see FIG. 9C after infiltration by CMAS).

The anti-CMAS layer 15 consisting of Gd₂Zr₂O₂ is obtained by SPS using a suspension not according to the invention, containing particles of Gd₂Zr₂O₂ having a d₉₀ of 0.89 μm and a d₅₀ of 0.41 μm. The layer is made on a self-supported substrate 11 made of zirconia stabilized in a phase t′ and obtained by APS.

In Examples 7 to 10 below, CMAS infiltration tests are carried out on the samples prepared in Examples 3 to 6.

In each of Examples 7 to 10, the CMAS (23.5% CaO—15.0% Al₂O₃—61.5% SiO₂—0% MgO (in weight %)) is deposited on the surface of each of the samples (30 mg/cm²). The sample is heated at 1250° C. for 1 hour.

At the end of the tests, each of the anti-CMAS layers has reacted and shows a drop of solidified CMAS on the surface of the sample.

At the end of the tests, a Scanning Electron Microscope (SEM) observation using backscattered electrons of a polished section of each of the samples was carried out.

For most samples, an Energy Dispersive Spectroscopy (EDS) analysis of the silicon of a polished section of the sample was also carried out.

### Example 7

In this example, a CMAS infiltration test was carried out according to the protocol described above, on the sample prepared in Example 3, and the sample was observed after infiltration.

FIG. 6 shows a Scanning Electron Microscope (SEM) micrograph using backscattered electrons of a polished section of the anti-CMAS layer 1 obtained by SPS in Example 3 at the surface of a columnar YSZ layer 8 obtained by EB-PVD.

The observation made after infiltration by the CMAS reveals on the surface the solidified CMAS 10 and a reaction zone 9 comprising the reaction products between the CMAS and the layer 1.

### Example 8

In this example, a CMAS infiltration test is carried out according to the protocol described above, on the sample prepared in Example 4, and the sample is observed after infiltration of CMAS.

FIG. 7A shows a micrograph taken with Scanning Electron Microscope (SEM) using backscattered electrons, and FIG. 7B shows an Energy Dispersive Spectroscopy (EDS) analysis of silicon of a polished section of the anti-CMAS layer 1 (13) obtained by SPS in Example 4 on, at, the surface of a YSZ layer 11 obtained by APS.

The observation is made here in an uncracked area, without cracks, in which there was no infiltration.

The observation made after infiltration of CMAS reveals on the surface the solidified CMAS 10 and a reaction zone 9 comprising the reaction products between the CMAS and the layer 1. The lighter zone on the EDS shot corresponds to either the solidified CMAS 10 or the reaction zone 9.

FIG. 8A shows another micrograph done with a Scanning Electron Microscope (SEM) using backscattered electrons, and FIG. 8B shows another EDS analysis of silicon of a polished section of the anti-CMAS layer 1 obtained by SPS in the Example 4 on the surface of a YSZ layer 11 obtained by APS.

The observation is made here in a zone having a crack 12 after CMAS infiltration and shows on the surface the solidified CMAS 10 and a reaction zone 9 comprising the reaction products between the CMAS and the layer 1 (13). The lighter zone on the EDS shot corresponds either to the solidified CMAS 10 or to the reaction zone 9, or to the degree of penetration within the crack of the CMAS or of the reaction products between the CMAS and the layer 1.

FIG. 9A shows yet another micrograph taken with a Scanning Electron Microscope (SEM) using backscattered electrons (left) and an EDS analysis of silicon (right) of a polished section of an anti-CMAS layer 13 of Gd₂Zr₂O₇ obtained in Example 4, by SPS, with initial particles having a d₉₀ of 7 μm and a d₅₀ of 3 μm. This layer is made on the surface of a YSZ layer 11 obtained by APS.

The observation is carried out in a zone having a crack after CMAS infiltration and reveals on the surface the solidified CMAS 10 and a reaction zone 9 comprising the reaction products between the CMAS and the layer 13. The lighter zone on the EDS shot corresponds either to the solidified CMAS 10 or to the reaction zone 9, or to the degree of penetration within the crack of the CMAS, or of the reaction products between the CMAS and the layer 13.

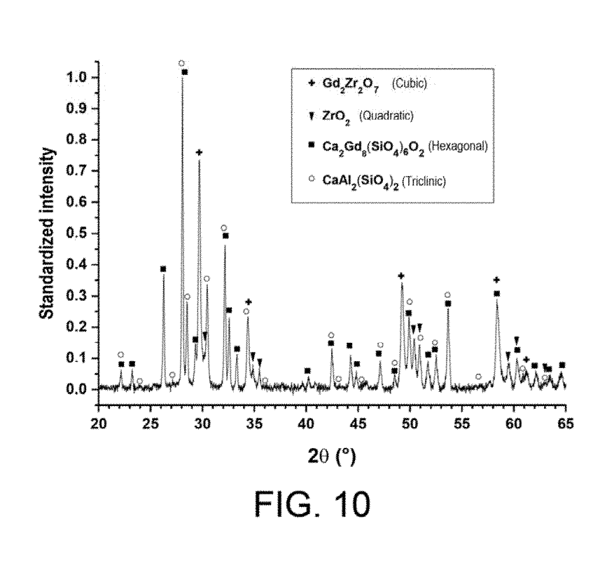

FIG. 10 shows a diffractogram obtained by X-ray diffraction after CMAS infiltration of the anti-CMAS layer 13. The analysis shows the presence of the initial material Gd₂Zr₂O₇, of an apatite phase Ca₂Gd₈(SiO₄)₆O₂, of an anorthite phase CaAl₂(SiO₄)₂ and of zirconia.

### Example 9

In this example, a CMAS infiltration test is carried out according to the protocol described above, on the sample prepared in Example 5, and the sample is observed after infiltration.

FIG. 9B shows a micrograph taken with a Scanning Electron Microscope (SEM) using backscattered electrons (left) and a silicon EDS analysis (right) of a polished section of an anti-CMAS layer 14 of Gd₂Zr₂O₇ obtained in Example 5, by SPS with initial particles having a diameter of 4.95 μm and a d₅₀ of 1.01 μm.

This layer is made on the surface of a YSZ layer 11 obtained by APS. The observation is carried out in a zone having cracking after CMAS infiltration and shows on the surface the solidified CMAS 10 and a reaction zone 9 comprising the reaction products between the CMAS and the layer 14. The lighter zone on the EDS shot corresponds either to the solidified CMAS 10 or to the reaction zone 9, or to the degree of penetration within the crack of CMAS, or of the reaction products between the CMAS and the layer 14.

### Example 10 (Comparative)

In this example, a CMAS infiltration test is carried out according to the protocol described above, on the sample not according to the invention prepared in Example 6, and the sample is observed after infiltration.

FIG. 9C shows a micrograph taken with a Scanning Electron Microscope (SEM) using backscattered electrons (left) and a silicon EDS (right) analysis of a polished section of the anti-CMAS layer 15 of Gd₂Zr₂O₇ obtained in Example 6, by SPS, with initial particles having a d₉₀ of 0.89 μm and a d₅₀ of 0.41 μm. This layer is made on the surface of a YSZ layer 11 obtained by APS. The observation is carried out in a zone having a crack after CMAS infiltration and shows on the surface the solidified CMAS 10 and a reaction zone 9 comprising the reaction products between the CMAS and the layer 15. The lighter zone on the EDS shot corresponds either to the solidified CMAS 10 or to the reaction zone 9, or to the degree of penetration within the cracking of the CMAS, or of the reaction products between the CMAS and the layer 15.

### Conclusion of Examples 1 to 10

Between the CMAS and the anti-CMAS layer, a reactive zone 9 composed of blocking phases is observed (FIG. 6, 7A, 7B, 8A, 8B, 9A, 9B, 9C).

The visualization of the CMAS and the reactive zone is also illustrated by the EDS shots shown in FIGS. 9A, 9B and 9C.

The phases present analyzed by X-ray diffraction comprise the initial material Gd₂Zr₂O₇, an apatite phase Ca₂Gd₈(SiO₄)₆O₂, an anorthite phase CaAl₂(SiO₄)₂ and zirconia (FIG. 10).

Whether it is through the porosity of the coating or cracks, the reactive zone 9 as well as the CMAS penetration within the anti-CMAS layer becomes more significant and more severe as the particle sizes decrease.

In particular, the layer 15 of Example 6 (FIG. 9C), which does not conform to the invention, has a much larger, much more severe infiltration, than the layers 13 and 14 according to the invention (FIGS. 9A and 9B).

The size of the particles of anti-CMAS material injected into the plasma jet generates a difference in the morphology of the porosity. In fact, the smaller particles offer, in particular, the liquid CMAS a greater number of entry points, and more numerous and direct propagation paths in the thickness of the layer. Thus, in Example 6, not in accordance with the invention, “small particles” are used in the suspension, and there is then an infiltration of the coating by the CMAS in the thickness of the coating.

The kinetics of penetration within the coating is in competition with the kinetics of reaction allowing the formation of effective blocking phases.

In the layers prepared by the method according to the invention, the reaction kinetics of CMAS with the material of the layers is faster than the kinetics of infiltration, i.e. penetration, of the CMAS in the porosity of the layers. In fact, the layers according to the invention, because they are prepared with suspensions which have a “large” particle size, therefore have a high tortuosity, which slows down the kinetics of infiltration, i.e. penetration, of the CMAS. The kinetics of CMAS penetration into the layers prepared by the method according to the invention is far less rapid than the reaction kinetics of CMAS with the material of the layers which allows the formation of effective blocking phases.

The kinetics of penetration of the anti-CMAS layer by CMAS at high temperature is slowed down for initial particles having sizes according to the invention. In this case, the anti-CMAS layer makes it possible as a result of the high tortuosity generated, to form the blocking phase and/or the blocking phases at the surface and/or at a shallow depth within the anti-CMAS layer.

The lowest degree of infiltration, at the cracks or at the uncracked zones, is observed for the layer 13 of Example 4 according to the invention.

### Example 11

In this example, an anti-CMAS layer according to the invention is prepared by the method according to the invention. The anti-CMAS layer 21 consisting of Gd₂Zr₂O₇ is prepared on the surface of a columnar YSZ layer 8, obtained by an EB-PVD method.

The anti-CMAS layer is prepared by an SPS method using a suspension containing initial particles having a d₉₀ of 13.2 μm and a d₅₀ greater than or equal to 1 μm, namely 5.5 μm.

The YSZ layer 8 is the same as the YSZ layer 8 of Example 3 but the layer 21 has a different particle size.

The thus prepared sample constituted by the anti-CMAS layer on the substrate falls within the scope of the system shown in FIGS. 1 and 2.

FIG. 11 shows a micrograph taken with a Scanning Electron Microscope (SEM) using backscattered electrons of a polished section of the sample prepared in this example.

### Example 12

In this example, an anti-CMAS layer according to the invention is prepared by the method according to the invention (see FIG. 12 after infiltration by CMAS). The anti-CMAS layer 21 consisting of Gd₂Zr₂O₇ is obtained by SPS using a suspension containing Gd₂Zr₂O₇ particles having a d₉₀ of 13.2 μm and a d₅₀ of 5.5 μm. The layer is made on a self-supported substrate 11 made of yttria-stabilized zirconia stabilized in a phase t′ and obtained by APS.

### Example 13

In this example, a CMAS infiltration test is carried out according to the protocol described above, on the sample prepared in Example 12, and the sample is observed after infiltration.

FIG. 12 shows a micrograph taken with a Scanning Electron Microscope (SEM) using backscattered electrons of a polished section of the anti-CMAS layer 21 obtained by SPS.

The observation is performed after infiltration by the CMAS, and reveals on the surface the solidified CMAS 10 and a reaction zone 9 comprising the reaction products between the CMAS and the layer 21.

### REFERENCES

[1] A. Feuerstein, J. Knapp, T. Taylor, A. Ashary, A. Bolcavage, N. Hitchman, “Technical and economical aspects of current thermal barrier coating systems for gas turbine engines by thermal spray and EBPVD: a review”, Journal of Thermal Spray Technology, 17, 2008, 199-213.
[2] N. Curry, K. Van Every, T. Snyder, N. Markocsan, “Thermal conductivity analysis and lifetime testing of suspension plasma-sprayed thermal barrier coatings”, Coatings, 4, 2014, pp 630-650.
[3] E. H. Jordan, L. Xie, M. Gell, N. P. Padture, B. Cetegen, A. Ozturk, J. Roth, T. D. Xiao, P. E. C. Bryant, “Superior thermal barrier coatings using solution precursor plasma spray”, Journal of Thermal Spray Technology, 13, 2004, pp 57-65.
[4] Z. Tang, H. Kim, I. Yaroslayski, G. Masindo, Z. Celler, D. Ellsworth, “Novel thermal barrier coatings produced by axial suspension plasma spray”, Proceeding of International Thermal Spray Conference and Exposition (ITSC), Hamburg, Germany, 2011.
[5] K. N. Lee, US-2009/0184280-A1.
[6] K. W. Schlichting, M. J. Maloney, D. A. Litton, M. Freling, J. G. Smeggil, D. B.

Snow, US-2010/0196605-A1.
[7] B. Nagaraj, T. L. Few, T. P. McCaffrey, B. P. L'Heureux, US-2011/0151219-A1.
[8] A. Meyer, H. Kassner, R. Vassen, D. Stoever, J. L Marques-Lopez, US-2011/0244216-A1.
[9] B. T. Hazel, D. A. Litton, M. J. Maloney, US-2013/0260132-A1.
[10] C. W. Strock, M. Maloney, D. A. Litton, B. J. Zimmerman, B. T. Hazel, US-2014/0065408-A1.

What is claimed is:

1-25. (canceled)

26. Method for coating at least one surface of a solid substrate with at least one layer comprising at least one ceramic compound by a Suspension Plasma Spraying (SPS) technique in which at least one suspension of solid particles of at least one ceramic compound is injected in a plasma jet and then the thermal jet containing the suspension of solid particles is sprayed onto the surface of the substrate, whereby the layer comprising at least one ceramic compound is formed on the surface of the substrate; method characterized in that in the suspension, at least 90% by volume of the solid particles have a largest dimension (called d₉₀), such as a diameter, less than 15 μm, preferably less than 10 μm, and at least 50% by volume of the solid particles have a largest dimension (called d₅₀) such as a diameter, greater than or equal to 1 μm; method further characterized in that the ceramic compound is selected from compounds known as anti-CMAS compounds, selected from rare earths zirconates of formula RE₂Zr₂O₇, where RE is Sc, Y, La, Ce, Pr, Nd, Pm, Sm, Eu, Gd, Yb, Dy, Ho, Er, Tm, Tb, or Lu, hexa-aluminates, aluminium silicates, yttrium silicates of yttrium or of other rare earths silicates, which silicates may be doped with one or more alkaline earth metal oxides, and mixtures thereof; preferably, the ceramic compound is Gd₂Zr₂O₇.

27. Method according to claim 26, wherein the layer has a lamellar microstructure and a tortuous porous network.

28. Method according to claim 27, wherein the layer comprises at the same time:
lamellae resulting from the melting of the solid particles of the suspension,
solid particles resulting from the partial melting of the solid particles of the suspension, and
unmelted solid particles of the suspension.

29. Method according to claim 26, wherein the layer has a porosity of 5 to 50% by volume, preferably 5 to 20% by volume.

30. Method according to claim 26, wherein the layer has a thickness of 10 μm to 1000 μm, preferably 10 μm to 300 μm.

31. Method according to claim 26, wherein the solid substrate consists of a solid support, which is, for example, in the form of a massive support or in the form of a layer, and the layer comprising at least one ceramic compound is deposited directly on at least one surface of said support.

32. Method according to claim 26, wherein the solid substrate consists of a solid support on which there is a single layer or a stack of several layers, and the layer comprising at least one ceramic compound is deposited on at least one surface of said single layer, or on at least one surface of the upper layer of said stack of layers.

33. Method according to claim 31, wherein the support is made of a material selected from materials sensitive to an infiltration and/or an attack by contaminants such as CMAS; in particular the support is made of a material chosen from metals, metal alloys such as superalloys, preferably monocrystalline superalloys, ceramic matrix composites (CMC) such as SiC matrix composites, C—SiC mixed matrix composites, and combinations and mixtures of the aforementioned materials.

34. Method according to claim 32, wherein the single layer or said stack of layers on the support forms a monolayer or multilayer thermal protection coating on the support, namely a thermal barrier system, and/or a monolayer or coating for protection against corrosive environments, namely an environmental barrier system.

35. Method according to claim 32, wherein the single layer is selected from bonding layers, and thermal or environmental barrier layers, such as layers, in particular ceramic layers which are thermally insulating layers, and layers, in particular ceramic layers which are anti-oxidation layers, and layers, in particular ceramic layers, which are anti-corrosion layers.

36. Method according to claim 32, wherein the stack of several layers on the support comprises, starting from the support:
a bonding layer which covers the support;
one or more layers chosen from among thermal barrier layers and environmental barrier layers, such as layers, in particular ceramic layers, which are thermally insulating layers, and layers, in particular ceramic layers, which are anti-oxidation layers, and layers, in particular ceramic layers, which are anti-corrosion layers;
or the stack of several layers on the support comprises:
several layers chosen from among thermal barrier layers and environmental barrier layers, such as layers, in particular ceramic layers, which are thermally insulating layers, layers, in particular ceramic layers, which are anti-oxidation layers, and layers, in particular ceramic layers, which are anti corrosion layers.

37. Method according to claim 35, wherein the thermal barrier layers and the environmental barrier layers, such as layers, in particular ceramic layers, which are thermally insulating layers, layers, in particular ceramic layers, which are anti-oxidation layers, and layers, in particular ceramic layers, which are anti-corrosion layers, are layers prepared by a technique chosen from among EB-PVD, APS, SPS, SPPS, sol-gel, PVD, CVD techniques, and the combinations of these techniques.

38. Method according to any one of claim 35, in which the thermal barrier layers are made of a material chosen from zirconium or hafnium oxides, stabilized with yttrium oxide or with other rare earths oxides, aluminium silicates, silicates or other rare earths silicates, wherein these silicates may be doped with alkaline earth metal oxides, and rare earths zirconates, which crystallize in a pyrochlore structure, and combinations and/or mixtures of the aforementioned materials, preferably the thermal barrier layers, are made of yttrium-stabilized zirconia (YSZ); and the environmental barrier layers are made of a material selected from aluminium silicates, optionally doped with alkaline earth elements, rare earth silicates, and combinations and/or mixtures of the aforementioned materials.

39. Method according to claim 35, wherein the bonding layer is made of a material selected from metals, metal alloys such as β-NiAl metal alloys, modified or not with Pt, Hf, Zr, Y, Si or combinations of these elements, γ-Ni-γ′-Ni₃Al metal alloys modified or not by Pt, Cr, Hf, Zr, Y, Si or combinations of these elements, MCrAlY alloys where M is Ni, Co, NiCo, Si, SiC, SiO₂, mullite, BSAS, and combinations and/or mixtures of the aforementioned materials.

40. Method according to claim 26, wherein the substrate consists of a support made of a metal alloy such as a superalloy or a Ceramic Matrix Composite (CMC), coated with a metal bonding layer that is itself coated with a layer, such as a ceramic layer selected from the thermal barrier layers and the environmental barrier layers.

41. Method according to claim 26, wherein the substrate consists of a support made of a metal alloy such as a superalloy or consists of a Ceramic Matrix Composite (CMC) coated with a metal bonding layer that is itself coated with a thermal barrier ceramic layer made of yttrine (Y₂O₃)-stabilized zirconia (ZrO₂).

42. Method according to claim 26, wherein the substrate consists of a support made of a metal alloy such as a superalloy or a Ceramic Matrix Composite (CMC), coated with a metal bonding layer that is itself coated with a thermal and/or environmental barrier ceramic layer produced by a technique selected from the APS, EB-PVD, SPS, SPPS, sol-gel, CVD techniques, and combinations of these techniques.

43. Substrate coated with at least one layer obtainable by the method according to claim 26.

44. Substrate according to claim 43, wherein the layer has a lamellar microstructure and a tortuous porous network.

45. Substrate according to claim 43, wherein the layer comprises at the same time:
lamellae resulting from the melting of the solid particles of the suspension,
solid particles resulting from the partial melting of the solid particles of the suspension, and
unmelted solid particles of the suspension.

46. Substrate according to claim 43, wherein the layer has a porosity of 5 to 50% by volume, preferably 5 to 20% by volume.

47. Substrate according to claim 43, wherein the layer has a thickness of 10 μm to 1000 preferably 10 μm to 300 μm.

48. Part comprising the coated substrate according to claim 44.

49. Part according to claim 48 which is a part of a turbine, such as a turbine blade, a distributor, a turbine ring, shroud or a part of a combustion chamber, or a part of a nozzle, or more generally any part subjected to attacks by liquid and/or solid contaminants such as CMAS.

50. Use of the layer obtainable by the method according to claim 26, for protecting a solid substrate against degradation caused by contaminants such as CMAS.
